(19) United States
(12) Patent Application Publication
(10) Pub. No.: US 2006/0144876 A1
(43) Pub. Date: Jul. 6, 2006

(54) Lock for a flat and low pourer with a removable element in the form of a laminate of film for a composite package for container openings closed by nonpermeable film

(75) Inventors: Markus Wassum, Gottmadingen (DE); Marlo Weist, Stuhlingen (DE)

Correspondence Address: EDWIN D. SCHINDLER, FIVE HIRSCH AVENUE, P.O. BOX 966, CORAM, NY, 11727-0966, US

(73) Assignee: SIG Technology Ltd., Neuhausen am Rheinfall (CH)

(21) Appl. No.: 10/550,812

(22) PCT Filed: Mar. 19, 2004
(86) PCT No.: PCT/CH04/00167

§ 371 Date: Nov. 10, 2005

(30) Foreign Application Priority Data
Mar. 26, 2003 (CH) 520/03

(51) Int. Cl. B67D 3/00; B67D 5/06

(52) U.S. Cl. 222/529

(57) ABSTRACT

A flat and low pourer closure for composite packs or container openings, which are preferably closed with a thick foil, includes a bottom part which, with the bottom side of its base plate, is intended to be welded, or otherwise fixed, on a composite pack or thick foil. The base plate has a drain opening and at least one projection which juts upwardly and surrounds the base plate. There is a cover which swivels on a hinge towards the bottom part and can be swiveled downwardly and tightly on the bottom part as a collar; which collar runs around the bottom side of the cover and matches with the one or more projections on the bottom part. In the internal drain opening on the base plate, a break-off plate, with its outer edge following the inner edge of the drain opening, is formed through at least two material bridges as breaking points. The bottom side of this break-off plate runs flush with the bottom side of the base plate and is preferably welded on a thick foil on a composite pack, which preferably covers a perforated hole therein. When the break-off plate is broken off, the welded piece is torn off from the thick foil and the composite pack is able to be opened.

This invention relates to a particularly flat and low pourer-closure for composite packs or container openings, which are closed with a thick foil, wherein it displays an arrangement for breaking off a piece of the composite packing laminate or a piece of the thick foil from the composite pack, which is fitted with the closure or from the thick foil of the container opening. For the composite packs, which are intended to be fitted with this closure, foil coated paper is considered for such packs in which liquids like milk, fruit juices, all types of non-alcoholic beverages or liquids in general, also from the non-food category, are packed. The closure can also be used in composite packs, in which bulk goods like sugar, grease or all types of chemicals and such items can be stored or packed. Foil coated paper means a laminated substance, somewhat akin to a paper or carton board, which is coated with a plastic like polyethylene, for example, and/or aluminium. Volumes of such packs usually range from 20 cl up to 2 litres and more. Further, this pourer-closure can be welded or glued on thick foils, with which a container opening is closed, irrespective of the shape and composition of the container. If it comes to a spot on the composite pack, where the closure is to be welded and, depending on the internal opening of the closure, the spot on the composite pack is to be prepared, the edge of a suitable hole is weakened through punching or the local carton layer is pre-weakened through a laser treatment, in which, however, the thick foil inside the composite pack laminate remains unscathed, or a complete hole is punched out from the laminate, the hole being closed afterwards with an individual thick foil.

Many forms of execution are known of the pourer-closures, which are made out of plastic and are to be welded on a composite pack or to be put on thick foils. They have a bottom part, which is welded on the composite pack and a cover part, which is attached thereto in a swivelling way through a hinge. The bottom part has around the internal opening of the closure an edge, which projects upwards and runs all around and forms a pouring beak at the front side of the bottom part. The hinging cover, formed at the rear side of the bottom part, has a ring wall projecting downwards, which matches with the internal space of the edge of the bottom part in the swivelled-shut condition of the cover and clicks within that in such a way that the pourer-closure can be shut tightly. When the cover part is opened for the first time, that means it is swivelled up for the first time, the area below the bottom part appears within the space of the upwardly projecting edge of the bottom part, said area being either pre-weakened along the length of the edge of the internal opening of the closure bottom part, or the thick foil comes to light, which overlaps the hole, which has been punched out locally in the composite pack. With its plain bottom side, the bottom part of the pourer closure is welded outside the hole on the composite pack. The standard composite pack is so constructed and prepared that at every point, where the internal space of the inner edge of the closure bottom part comes to rest, the edge of a hole on the composite pack is embossed beforehand or at least is weakened through a perforation or a thick foil is merely glued on the hole, which has been stamped out before. Such a thick foil is made of, for example, an aluminium foil, which is bonded with the carton layer of the pack at the inner side of the composite pack. It can also be made of a PE-coating, which can be welded on the carton material of the composite pack by means of high frequency welding in a manner that it spans the respective perforation, over which the pourer-closure is later welded.

When the closure is opened for the first time and its cover part is swivelled up, depending on the type of configuration, an area, which is weakened at the edge, or a thick foil, appears at the inside of the upwardly projecting edge of the closure bottom part; it can be an aluminium foil or a PE foil. The foil or the area, which is weakened at the edge, is then first pressed with one finger by the user, after which the contents of the pack can be poured out through the spout, formed at the front side of the pouring piece, which is built by the projecting edge of the closure bottom part.

These conventional pourer-closures have some deficiencies. Firstly, the closures of such type and form have a large construction height, which means that they confer too much of a height on the composite packs on which these are fitted; the possibilities of stacking such composite packs thus become unduly restricted and extra spacer blocks must be provided to stack the composite packs in several layers. That, however, makes the stack higher than what is theoretically necessary due to the heights of the spacer blocks or at least due to the added heights of the closures. Likewise, the stackability in shelves is of great significance to the wholesaler as well as to the retailer because space costs money.

For many conventional solutions, another particular disadvantage lies therein that after the cover part has been swivelled up the first time, the closure must be opened separately through pressing in the area, which is weakened at the edge or through pressing in the thick foil and this takes place by the finger of the user. This method of opening of the thick foil or the composite pack is, however, unhygienic. When the user opens the pack with unclean fingers, bacteria can enter the contents of the pack and can multiply there; if the content of the pack is a foodstuff or a beverage, a person can later put it in the mouth, which can prove infectious.

Further, for the conventional closures, the spot, which is weakened at the edge, or the thick foil in general cannot be removed cleanly and completely from the internal area inside the projecting edge. Moreover, they are often torn open somewhere in the middle of their area and then, the two remaining pieces or flaps at the left or right of the break line, are pressed down unintentionally into the inside space of the composite pack. They thus form on both sides frayed brows, which project downward inside the composite pack and restrict and disturb the free and clean flow of the contents while pouring out. If the composite pack is swivelled all too heavily to the pouring position, due to the customary small dimensioning of the internal opening of the bottom part, enough amount of air inside the composite pack cannot flow out. This leads to disturbing bubbles, which means that an unstable, torrent like outflow of the liquid content ensues, which makes it difficult to pour out a desired amount of content into a glass or container. Moreover, the pouring spouts of the closures are often not formed properly, so that when the pouring ceases, due to force of adhesion, the liquid runs downwards at the outer surface of the spout and then over the composite pack to the bottom. Such dripping of liquid is very irritating because it makes the front side of the composite pack often very dirty.

For many conventional closures, the cover part does not hold reliably by itself in the open position of the cover and, due to a material stress in the hinge area, it swivels shut slowly, thereby disturbing the pouring jet. The situation then demands that one holds the cover part consciously with one hand in the open position, which is, however, awkward. In many instances, one hand is used to hold the composite pack and serve while the other hand holds a glass, in which the content is to be poured out. No hand is then free to hold the cover part in the open position.

Many conventional pourer-closures moreover have less user-friendly guarantee fittings, through which the first opening, that is, the first time swiveling up of the upper part of the closure is to be guaranteed. In some applications, a guarantee band has to be broken off and it must be held with two fingers. It proves practically difficult. If the user has handled, for example, a hand- or suntan cream shortly beforehand, it becomes difficult for him to break off the guarantee band as long as his fingers are oily. Opening of the closure with gloves is just not possible. Finally, the re-closure is also not done satisfactorily, since the closure is not adequately tight after the cover has been swiveled shut.

It is therefore necessary to find remedy to these problems and to create a pourer-closure for composite packs or for a container opening, which is closed with a thick foil, said pourer-closure with minimum built-up height allowing for the user a hygienic, simple, clean and reliable opening and complete removal of the portion, which is weakened at the edge or of the thick foil, spanning the internal width of the drain, so that a bubble free, continuous pouring out in a thick jet of fluid becomes possible. Further, the closure should remain in open position, whereby its cover cannot swing back by itself on the bottom part and finally, through swiveling the cover down on the bottom part, the closure should be able to be adequately shut, so that fluid from the composite pack cannot run out easily.

This objective is fulfilled through a flat, low pourer-closure for composite packs or for container openings, which are closed with thick foils, said pourer-closure comprising a bottom part, which, with the bottom side of its base plate, is intended to be welded on a composite pack or a thick foil, wherein the base plate has a drain opening as well as an upward projection, surrounding this base plate on the outside, and a molded cover, which can be swung through a hinge on this bottom part, it being able to be swiveled up and swiveled down tightly on the bottom part, with continuously running collar at the bottom side of the cover, matching with the projection on the bottom part, where this pourer-closure is characterized in that in its internal drain opening on the base plate, a break off plate with its external edge following the inner edge of the drain opening, is formed through at least two material bridges, which are laid out as two breaking points, the bottom side of the break off plate being flush with that of the base plate.

An advantageous embodiment of this particularly flat and low pourer-closure for composite packs or for container openings, which are closed with thick foils, are shown with different views in the Figures. The pourer-closure is described subsequently with the help of these Figures individually and its functioning is explained and clarified.

It is shown in:

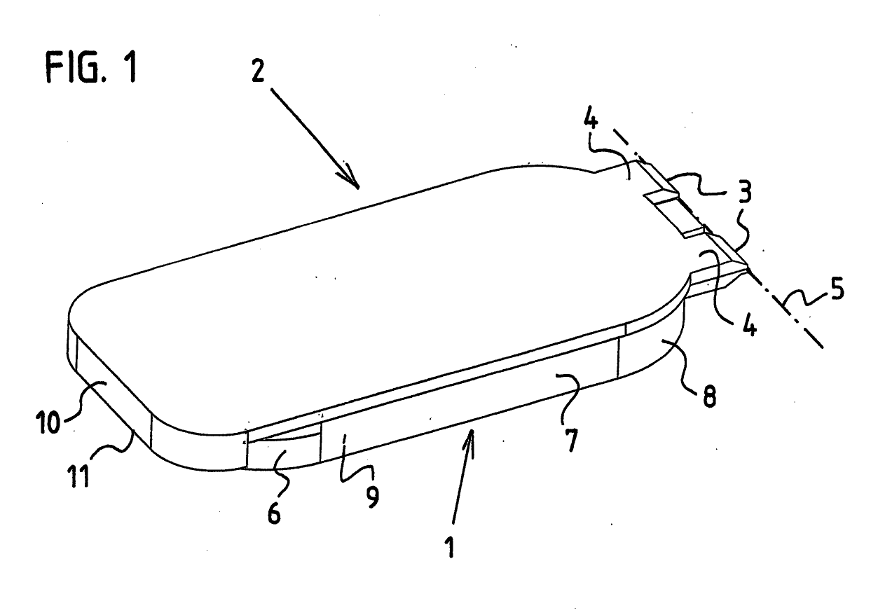

FIG. 1: A perspective view of the flat and low pourer-closure in closed condition, viewed at an angle from top;

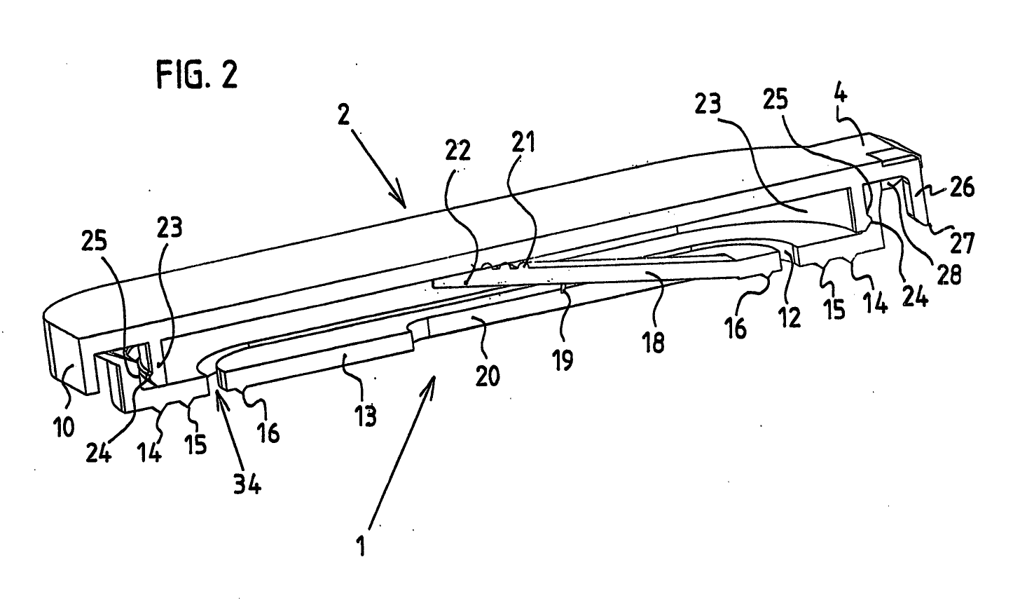

FIG. 2: A perspective view at an angle from the top of the pourer-closure as per FIG. 1 in closed condition, however in a longitudinal section;

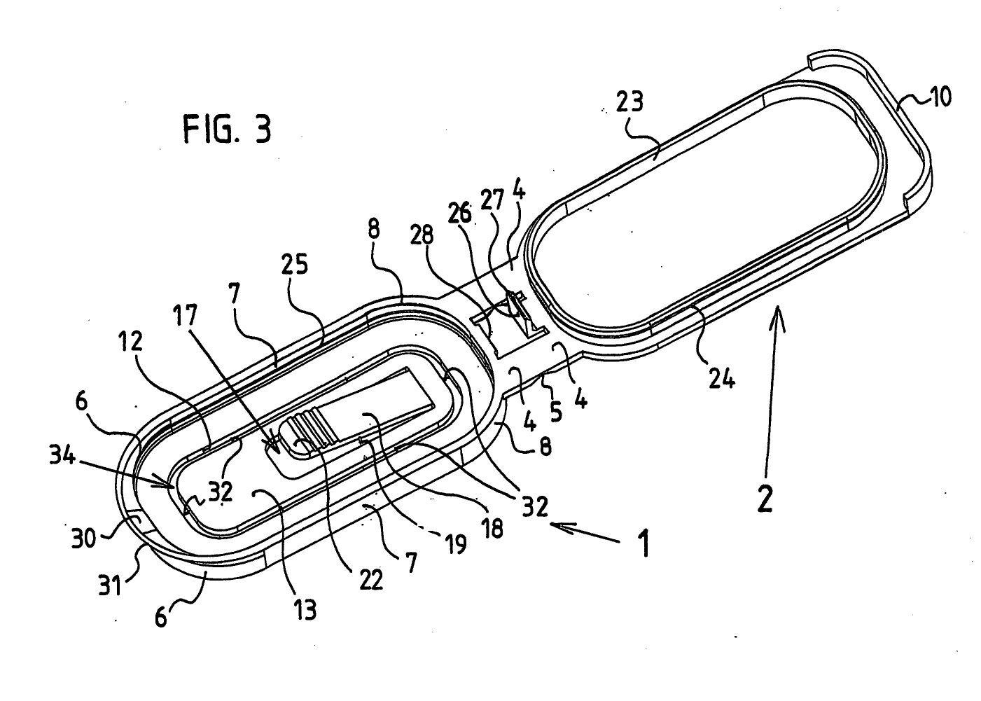

FIG. 3: A perspective view at an angle from the top of the pourer-closure as per FIG. 1 with its cover swiveled up by 180 degrees in yet un-opened condition of the composite pack, that is, with its break off plate intact;

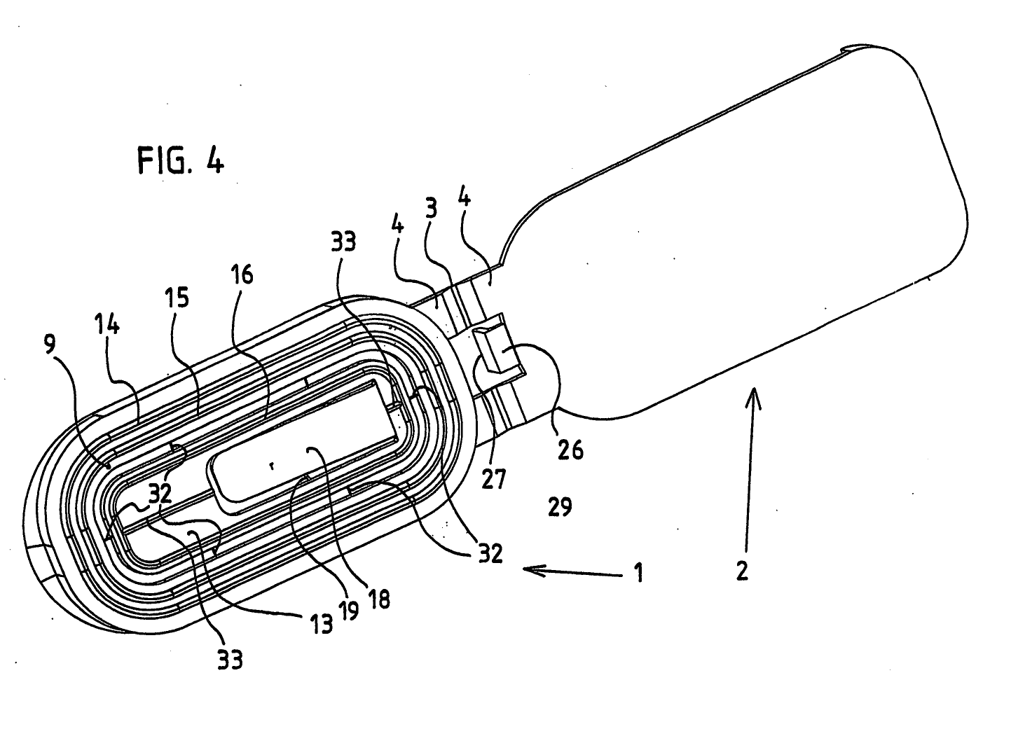

FIG. 4: A perspective view of the pourer-closure as per FIG. 1, viewed from the bottom, with the cover swiveled up by 180 degrees in yet un-opened condition of the composite pack, that is, with its break off plate intact.

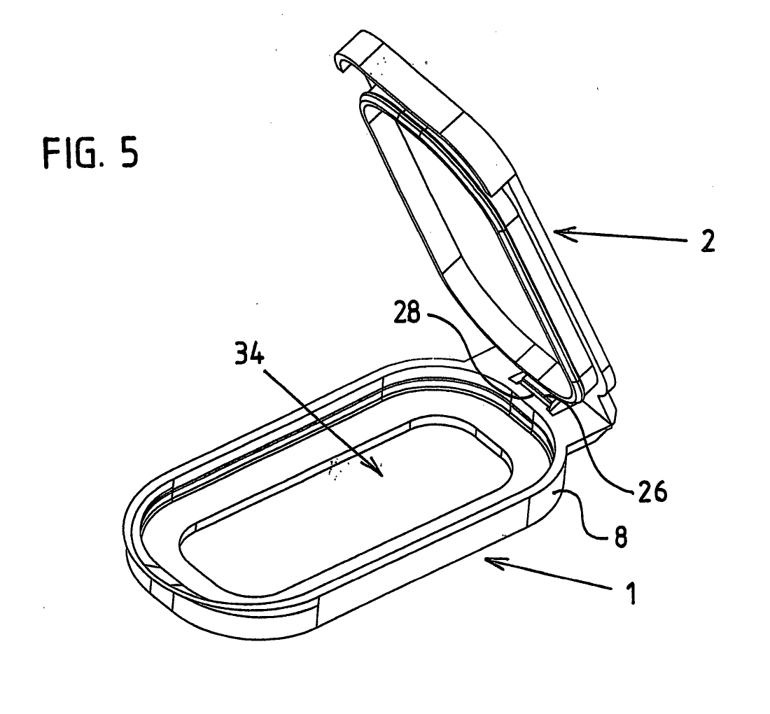

FIG. 5: A perspective view at an angle from the top of the pourer-closure as per FIG. 1 with the cover swiveled up by about 60 degrees in the opened condition of the composite pack, that is, with the break off plate removed.

In FIG. 1, a composite view in closed condition of this particularly flat and low pourer-closure, made out of injection molded plastic, for a composite pack is shown in perspective. The same closure, however, can be welded or glued on a thick foil, with which the opening of a container can be closed. To give an idea of the scale of size of the closure, which is illustrated here in an essentially enlarged diagram, the following dimensions are mentioned: the width is approximately 20 mm, the length approx. 45 mm and the height above all only 4 mm and these with a material thickness for cover and bottom part of about 1 mm. It should be understood at the outset that these dimensions are not binding and that, according to the technology evolved, still smaller or bigger closures can be realized with different relationships between length, width and height. In the closure shown here, one can identify only the bottom part 1 with the cover 2, which is swiveled upon that and also the film like hinge 3, which is required for swiveling; against the closure parts, namely the bottom part 1 and the cover 2, the film like hinge 3 is somewhat shifted back on the hinge lever 4. The hinge axis 5 is therefore shifted back against the swiveling parts so that, when the cover 2 is swiveled shut on the bottom part 1, in the back region of the cover 2, a path is covered by the same, which makes it possible to provide a snapping arrangement in such a way that both the parts can be click fixed with each other, thereby guaranteeing a tight closure of the cover 2 on the bottom part 1. The bottom part 1 of the closure has a projection 6-8 jutting upwards, which encloses all round the base plate 9. The bottom part 1 has an outline in the shape of a zero, that is, essentially a rectangular shape with rounded edges. The upwardly jutting projection at the outer edge comprises of the straight section 7 as also the curved sections 6,8. The cover 2 shows a flat, plain at top and continuous top side and a holding strip 10 at the front side of the cover 2 which projects about ⅔^{rd} to ¾^{th} of the height of projection on the bottom part 1 on the same. The lower edge 11 of the holding strip 10 can thus be gripped from the front side by a fingernail, preferably of the thumb or the index or middle finger and then the cover can be swiveled up by lifting the holding strip 10. The holding strip 10 can be pulled up even with gloves on since the material is softly elastic and hence the front end portion of the cover 2 in front of the front projection on the bottom part 1 can be easily bent upward.

In FIG. 2, the pourer-closure as in FIG. 1 is shown in closed position but in a longitudinal section in perspective, as seen from an angle at the top. Therefore, the inside of the closure can be seen, where one can see that the base plate 9 of the bottom part 1 has a drain opening 34, whose contour or edge 12 shows the outline in the shape of a zero, that is, a rectangle with rounded corners. Within this internal drain opening 34, a break off plate 13 with its outer edge is connected to the inner edge 12 of the drain opening through at least two material bridges, which are formed as breaking points (not shown here). The bottom side of this break off plate 13 is flush with the bottom side of the base plate 9. The bottom sides of the base plate 9 and of the break off plate 13 are provided with welding ridges 14, 15, 16. These welding ridges run all over the respective parts along their edges. These ridges serve as welding material when the closure is to be welded to a composite pack, which means that these ridges melt. When welding takes place through a standard ultrasonic welding method, these ridges are heated by ultrasound, melt and contribute to internal fusion of the closure, which means a fusion of the bottom part 1, the break off plate 13 with the plastic film on the composite laminate, which runs between them and is similarly brought to the melting zone by the ultrasound. The break off plate 13, however, has within itself an internal opening or recess 17, within which, a tongue 18 is connected to the rear edge section of the internal opening 17 through a narrow section, and even in a position, as is shown here, where the tongue 18 projects out of the internal opening 17 at a slight angle upward. To hold the tongue 18 securely in this position, the tongue is supported on both sides by fine supporting ribs 19 against the sidewise edges 20 of the internal opening 17. These supporting ribs 19 can be connected with the edges 20 of the internal opening 17 or can even be laid out loosely on them, depending on the type of construction. They only have the task to ensure that the tongue 18 does not swing into the internal opening since it can no longer be gripped in this position. For gripping the tongue 18, which projects out of the internal opening 17 at an angle, it is even provided with flutes 21 at the end, so that a hilt for the tongue 22 is actually formed there. The downward projecting collar 23 at the bottom side of the cover 2 is shifted slightly from the outer edge of the cover 2 inwards and it has a bead 24 at its lower, outer collar end, the bead helping the all round clicking-in of the cover 2 on the inner side of the upwardly jutting projections 6, 7, 8 on the bottom part 1. These projections (overhang) 6, 7, 8 accordingly are equipped with a similar bead 25, which is slightly taller than the bead 24 of the cover 2 in its closed position, so that the bead 24 on the cover collar 23 slides over the bead 25 on the inner side of the projection 6, 7, 8 and clicks at its back when the cover 2 is swiveled shut. This clicking-in takes place through slight deformation of the collar 23 and projection 7, 6, 8 against each other. In any case, cover 2 is held firmly in the closed position and it also displays adequate tightness. Opening by only lifting the holding strip 10 is possible because the material thickness of the cover 2 as well as the bottom part 1 lies in the region of about 1 mm and the parts are therefore suitably flexible; their geometrical proportions also are thus sufficiently variable, which renders clicking out of the beads 24, 25 possible. It has to be mentioned that right at the back of cover 2 and between the two hinge levers 4, a tooth 26 is formed, projecting downward. When the cover 2 is swiveled around the effective hinge axis 5, the pointed edge 27 of this tooth 26 strikes clockwise on the projected extension 28, as shown in the illustration here, at the rear outer side of a projection on the bottom part 1. An elastic deformation of the tooth 26 takes place during the striking of the extension 28, which entails that cover 2 can no longer swivel back by itself on the bottom part 1 because then tooth 26 holds on the extension 28 and it blocks cover 2 when it is in open position of at least 60 degrees.

In FIG. 3, the pourer-closure as per FIG. 1 is shown with cover 2 swiveled up by 180 degrees, however, in not-yet-opened position of the composite pack, on which it is either welded or stuck. In this view, the already described detention tooth 26 with its sharp edge 27 at the rear end of the cover 2 is visible particularly well together with the outwardly projecting extension 28 at upper outer edge of the projection at the back of the bottom part 1. Both these elements are arranged between the hinge levers 4, on both the parts 1, 2 in the recess 29, which is subject to alteration. On the bottom side of the cover 2, approximately 1 mm thick molded collar 23 with its fine bead 24, formed on and along its outer side, can be seen. As its counterpart, acts the bead 25 or a light depression on the outer side of the projection 6, 7, 8 on the bottom part 1. This projection is somewhat extended at the front on the bottom part and is tilted against the front side, so that a pouring lip 30 with sharp break off edge 31 is formed. Within the bottom part 1, its base plate 9 can be identified, from which an internal drain opening 34 has been taken out, which has the edge 12 at its border. Inside this edge 12, the break off plate 13 can be seen, which follows the contour of the edge 12 and, as shown in the example here, is connected with the same through six fine material bridges. The bottom side of this break off plate 13 is flush with the bottom side of the base plate 9 of the bottom part 1. On its part, within the break off plate 13, there is a recess 17, in which a tongue 18 is formed and it is formed only at the back side on the local edge of the recess 17, due to which and also due to the elasticity of the material, which has a thickness of the order of 1 mm, it can be swiveled upwards. To prevent the tongue 18 from completely swinging into the recess 17 of the break off plate 13, it is equipped on both its longitudinal edges with supporting ribs 19, by which it is supported at the edge of the recess 17; preventing its swinging out in the recess 17. These supporting ribs 19 can be part of the recess 17; these, however, can also be supported loose on the same. At the front end of the tongue 18, flutes 21 are provided. It can therefore be held easily in a non-slip way at the front end and later swung up. To open the closure effectively, which means to open a composite pack, which has been fitted with it, the tongue 18 is held at its end 22 and swung up. With a firm breaking off movement, the complete break-off plate 13 is broken free from the bottom part 1 of the closure, the material bridges 32 also breaking at the same time. Correspondingly, the piece of thick foil, on which the bottom side of the break-off plate was welded or glued, is torn off from the composite pack and makes the punched out hole free, on which the thick foil had been glued or welded.

In FIG. 4, the pourer-closure is shown with its cover 2 swiveled up by 180 degrees and in not-yet-opened position of the composite pack, that is, with break off plate 13 intact but in perspective view, as seen from below. It is seen here once again that the top side of the cover 2 is totally smooth and plain to meet the requirement of creating a flat closure as far as possible with minimum construction height. The recess 29, with the tooth 26 projecting in to it, lies between the hinge levers 4 and a film hinge 3, which is realized through a thin position. On the visible bottom side of the closure bottom part 1, the two welding ridges 14, 15 are seen on the base plate 9 and the welding ridge 16 is seen on the break off plate 13. As can be seen, one more welding ridge 33 extends lengthwise centrally over the break off plate 13. It is important that the break off plate 13 is welded or pasted with tensile force on the thick foil, which is pasted over the punched out hole, so that when it is broken off, the thick foil piece also gets actually torn off. Further in this Figure, the tongue 18 with its supporting ribs 19 as well as the material bridges 32, through which the break off plate 13 is held on the base plate 9 of the bottom part 1.

In FIG. 5, the pourer-closure as per FIG. 1 is finally shown with the cover 2 swiveled up by approximately 60 degrees and in open position of the composite pack, that is, with the break off plate broken off. The internal drain opening 34 is thus completely released and a congruent piece of thick foil has been torn off from the thick foil over the composite material, so that the internal drain opening 34 can be fully utilized. As one can see here, the tooth 26 on closure cover 2 stays put on the extension 28 at the back side of the projection 8 and holds the cover 2 open in the shown swiveled position.

1-8. (canceled)

9. A flat and low pourer-closure for composite packs or container openings closable with a thick foil, comprising:
a bottom part having a base plate fixable onto a composite pack or thick foil, said base plate having a drain opening and an upwardly jutting projection surrounding said base plate on an outer side;
a hinged cover swivelable toward said bottom part for swiveling upwardly and tightly swiveling downwardly onto said bottom part, said hinged cover having a downwardly projecting collar running around a bottom side of said hinged cover and corresponding with said upwardly jutting projection of said bottom part;
a break-off plate in said drain opening of said base plate with said break-off plate having an outer edge connected to an inner edge of said drain opening through material bridges as breaking points, so that a bottom side of said break-off plate runs flush with a bottom side of said base plate, said break-off plate having a recess, wherein at an edge position, a tongue is formed for allowing said break-off plate to be torn off by breaking said material bridges from said drain opening of said base plate after upwardly swiveling said hinged cover.

10. The flat and low pourer-closure for composite packs or container openings closable with a thick foil according to claim 9, wherein said tongue of said break-off plate includes supporting ribs at a lengthwise side of said tongue for holding said tongue in a slanted-up position in said drain opening of said base plate.

11. The flat and low pourer-closure for composite packs or container openings closable with a thick foil according to claim 9, further comprising a first bead and a second bead with said first bead formed along a length of an outer side of said downwardly projecting collar on said bottom said of said hinged cover, said first bead being capable of being clicked-in behind said second bead when said hinged cover is downwardly swiveled, said second bead being formed along a length of an inner side of said upwardly jutting on said bottom part.

12. The flat and low pourer-closure for composite packs or container openings closable with a thick foil according to claim 9, wherein said hinged cover has a hinge with two hinge levers and an open space between said two hinge levers with a tooth having a sharp edge, located within the open space, formed at a back edge of said cover, said tooth projecting and, while said cover swivels downwardly for closing, striking an extension projecting into the open space wherein, during an elastic deformation of said tooth, said sharp edge of said tooth is passable over said extension.

13. The flat and low pourer-closure for composite packs or container openings closable with a thick foil according to claim 9, wherein said hinged cover is a continuous cover plate having a holding strip at a front end of said hinged cover, said holding strip projecting downwardly is two-thirds to three-quarters in length as a height of said upwardly jutting projection of said bottom part.

14. The flat and low pourer-closure for composite packs or container openings closable with a thick foil according to claim 9, wherein said bottom part and said bottom side of said break-off plate have welding ridges for fixing, via welding, a thick foil or a composite pack with which said flat and low pourer-closure is to be fitted.

15. The flat and low pourer-closure for composite packs or container openings closable with a thick foil according to claim 9, wherein said upwardly jutting projection of said bottom part forms a pourer lip at a front end of said bottom part with said pourer lip having a sharp break-off edge.
